(19) United States
(12) Patent Application Publication
(10) Pub. No.: US 2010/0139634 A1
(43) Pub. Date: Jun. 10, 2010

(54) POSITIVE CRANKCASE VENTILATION VALVE ASSEMBLY WITH A VACUUM PULSATION DAMPENER

(76) Inventor: Tim Wade, Rochester Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/909,303

(22) PCT Filed: Mar. 23, 2006
(86) PCT No.: PCT/US06/10598

§ 371 Date: Sep. 21, 2007

Related U.S. Application Data
(60) Provisional application No. 60/664,750, filed on Mar. 24, 2005.

(51) Int. Cl. F02B 25/06

(52) U.S. Cl. 123/574

(57) ABSTRACT

A PCV valve assembly includes a housing that is defined by a first housing section and a second housing section. A poppet valve is supported within the housing. The first housing section includes a threaded end that defines a fluid inlet, and the second housing section includes a cylindrical outlet stem and an end flange that defines a restricted integral orifice as a fluid outlet. The diameter of the orifice is smaller than the diameter of the cylindrical outlet stem. A fluid chamber between the end flange and the poppet valve averages out variations in the fluid flow through the PCV valve assembly, thereby reducing vacuum pulsation.

### REFERENCE TO RELATED APPLICATION

This application claims priority to U.S. Provisional Application No. 60/664,750 which was filed on Mar. 24, 2005.

### BACKGROUND OF THE INVENTION

The present invention relates generally to a positive crankcase ventilation ('PCV) valve assembly, and more particularly to a PCV valve assembly having a restricted outlet orifice that reduces vacuum pulsations within the PCV valve assembly.

An engine system includes an intake manifold that supplies an air/fuel mixture to engine cylinders. Some of the air/fuel mixture leaks past pistons in the engine cylinders and into a crankcase. The engine cylinders generate a pulsed source vacuum that draws unburned combustion gases from the crankcase. A PCV valve assembly controls the flow of the unburned combustion gases from the crankcase and into the intake manifold to reduce emissions as air pollution. The PCV valve assembly includes a poppet valve in a housing that controls and varies the flow of the unburned combustion gases through the PCV valve assembly.

Recirculation of the unburned combustion gases is done in a continuous and metered manner to not disrupt the air/fuel mixture ratio and is critical to obtain desirable engine operation and emissions. Additionally, recirculation of the unburned combustion gases prevents blowby gas and water vapor from contaminating oil in the crankcase, reducing the formation of engine sludge.

A drawback to prior PCV valve assemblies is that the pulsed source vacuum generated by the engine cylinders can cause the poppet valve to vibrate, sometimes audibly. Disadvantageously, added vibration may increase wear and noise. Also, the vibrations may cause the poppet valve to be skewed along an axis of travel as the poppet valve moves within the housing.

Accordingly, it is desirable to provide an improved PCV valve assembly that significantly reduces vibrations of the poppet valve and provides a more consistent flow of unburned combustion gases through the PCV valve assembly.

### SUMMARY OF THE INVENTION

An engine system includes an intake manifold, a crankcase and a PCV valve assembly. A first vacuum tube connects the PCV valve assembly to the crankcase through a valve cover, and a second vacuum tube connects the PCV valve assembly to the intake manifold. The intake manifold supplies an air/fuel mixture to engine cylinders. During operation of the engine system, a variable amount of gases and vapors leak past pistons in the engine cylinders and into the crankcase. The engine cylinders create a pulsed source vacuum that draws the unburned gases and vapors from the crankcase.

The PCV valve assembly controls the flow of the unburned combustion gases from the crankcase and into the intake manifold to reduce emissions as air pollution. The PCV valve assembly includes a housing that is defined by a first housing section and a second housing section. The first housing section includes a threaded end that defines a fluid inlet. The second housing section includes a cylindrical outlet stem and an end flange that defines a fluid outlet.

A poppet valve is supported in a fluid passage within the housing between the fluid inlet and the fluid outlet. A resilient member disposed within the housing biases the poppet valve to a desired position in response to changes in pressures acting upon the poppet valve.

The fluid outlet is a restricted integral orifice that is integrally molded within the end flange. The diameter of the orifice is smaller than the diameter of the cylindrical outlet stem. The orifice dampens the vacuum pulsation generated from the engine cylinders. A fluid chamber defined between the end flange and the poppet valve averages out variations in the fluid flow through the PCV valve assembly, thereby reducing vacuum pulsation. The orifice allows the poppet valve to operate in a more stable manner due to the reduction in vacuum pulsation within the PCV valve assembly, reducing erratic flow and noise issues.

These and other features of the present invention will be best understood from the following specification and drawings.

### BRIEF DESCRIPTION OF THE DRAWINGS

The various features and advantages of this invention will become apparent to those skilled in the art from the following detailed description of the preferred embodiment. The drawings that accompany the detailed description can be briefly described as follows:

FIG. 1 illustrates an engine system incorporating a PCV valve assembly;

FIG. 2 is a perspective view of a first embodiment of the PCV valve assembly according to the present invention;

FIG. 3 is a cross-sectional view of the PCV valve assembly shown in FIG. 2; and

FIG. 4 is a second embodiment of the PCV valve assembly of the present invention.

### DETAILED DESCRIPTION OF THE PREFERRED EMBODIMENT

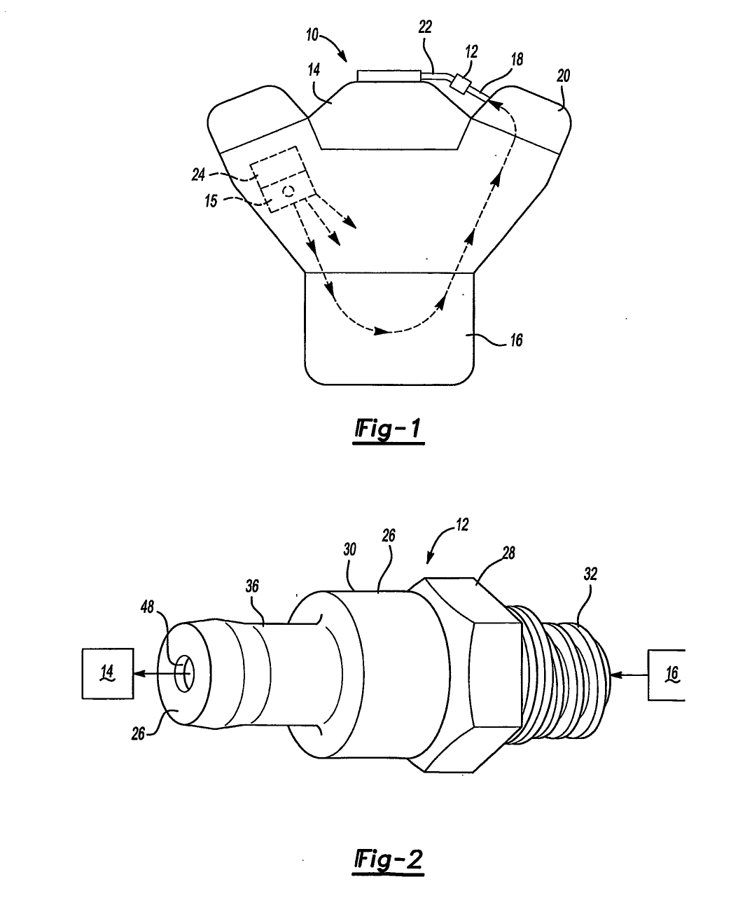

FIG. 1 schematically illustrates an engine system 10 incorporating a PCV valve assembly 12. The engine system 10 includes an intake manifold 14 and a crankcase 16. A first vacuum tube 18 connects the PCV valve assembly 12 to the crankcase 16 through a valve cover 20, and a second vacuum tube 22 connects the PCV valve assembly 12 to the intake manifold 14. Preferably, the vacuum tubes 18 and 22 are connected to the valve cover 20 and the intake manifold 14, respectively, by a clamp.

The intake manifold 14 supplies an air/fuel mixture to engine cylinders 24. During operation of the engine system 10, a variable amount of gases and vapors leak around pistons 15 in the engine cylinders 24 and into the crankcase 16. The engine cylinders 24 generate a pulsed source vacuum that draws unburned combustion gases from the crankcase 16.

The PCV valve assembly 12 controls the flow of the unburned combustion gases from the crankcase 16 and into the intake manifold 14 for re-burning. The PCV valve assembly 12 keeps the air/fuel ratio at a desired amount. The flow of the unburned combustion gases is shown as a broken arrow in FIG. 1.

Recirculation the unburned combustion gases eliminates crankcase 16 emissions as a source of air pollution. The constant recirculation of air through the crankcase 16 helps to remove moisture, which could cause sludge to form in the crankcase 16, extending the life of the oil and the engine. The unburned combustion gases can also be corrosive, and the recirculation reduces corrosion.

Referring to FIG. 2, the PCV valve assembly 12 includes a housing 26 that is defined by a first housing section 28 and a second housing section 30. The first housing section 28 and the second housing section 30 are secured to one another in any manner known in the art to form the housing 26. In one example, the housing 26 is molded from plastic.

The first housing section 28 includes a threaded end 32 that defines a fluid inlet 34. The vacuum tube 18 is connected to the threaded end 32 to provide a fluid connection between the crankcase 16 and the PCV valve assembly 12. The second housing section 30 includes a cylindrical outlet stem 36 and an end flange 38 that defines a restricted integral orifice 48 as a fluid outlet. The orifice 48 is molded in the end flange 38.

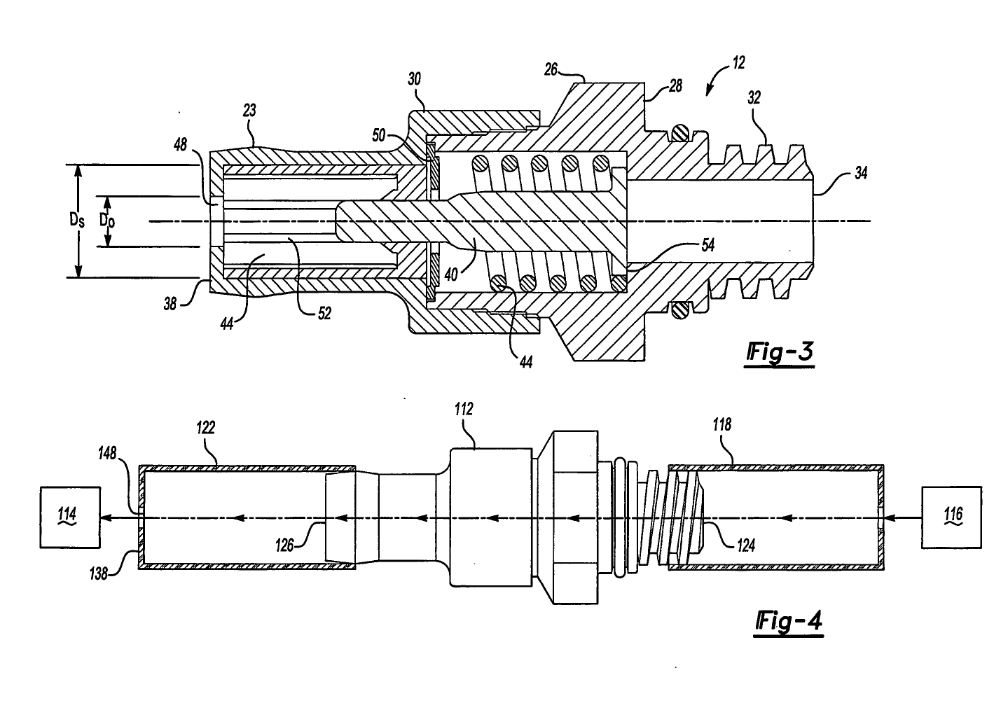

Referring to FIG. 3, a poppet valve 40 is supported within the housing 26 between the fluid inlet 34 and the fluid outlet. The poppet valve 40 moves within a fluid passage 42 arranged within the housing 26 between the fluid inlet 34 and the fluid outlet. A resilient member 44, such as a spring, is disposed within the housing 26 and biases the poppet valve 40 to a desired position in response to changes in pressure acting upon the poppet valve 40.

When the engine is not operating, the resilient member 44 biases the poppet valve 40 against a valve seat 54, preventing the unburned combustion gases from the crankcase 16 from flowing into the intake manifold 14. When the engine is running normally, the engine cylinders 24 create a low vacuum. The pressure acting upon the poppet valve 40 increases, and the poppet valve 40 moves in the axial direction (to the left as shown in FIG. 3) away from the valve seat 54, compressing the resilient member 44 and permitting an increased flow of the unburned combustion gases though the fluid passage 42 of the PCV valve assembly 12 and into the intake manifold 14 for burning. When the pressure acting upon the poppet valve 40 dissipates, the vacuum is eliminated, and the resilient member 44 expands to bias the poppet valve 40 in the reverse axial direction (to the right as shown in FIG. 3) towards the valve seat 54, reducing the flow of unburned combustion gases through the fluid passage 42 of the PCV valve assembly 12.

The orifice 48 is integrally molded within the end flange 38 to define the fluid outlet of the PCV valve assembly 12. The end flange 38 extends substantially perpendicular to the cylindrical outlet stem 36. The pulsed source vacuum generated by the engine cylinders 24 can cause the poppet valve 40 to vibrate. The orifice 48 is sized to dampen the vacuum pulsation generated from the engine cylinders 24. The size of the orifice 48 is established by first determining a maximum fluid flow through the PCV valve assembly 12. The orifice 48 is sized to a diameter which is slightly larger than the diameter needed to achieve the maximum fluid flow. The diameter Do of the orifice 48 is smaller than the diameter Ds of the cylindrical outlet stem 36. In one example, the orifice 48 has a diameter of approximately 0.050 to 0.250″.

In prior PCV valve assemblies, there is no flange extending from the cylindrical outlet stem, and the fluid flows through the cylindrical outlet stem and into the vacuum tube unimpeded. In the present invention, a fluid chamber 46 between the end flange 38 and the poppet valve 40 averages out variations in the fluid flow through the PCV valve assembly 12, thereby reducing vacuum pulsation.

An orifice plate 50 may be arranged within the housing 26 between the first housing section 28 and the second housing section 30 to define a flow rate through the fluid passage 42 of the PCV valve assembly 12. Ribs 52 are supported within the fluid passage 42 of the second housing section 30 and extend radially inwardly from the housing 26. The ribs 52 facilitate the travel of the poppet valve 40 as it travels in the axial directions to open and close the fluid passage 42. As can be appreciated by those skilled in the art, the orifice 48 and the ribs 52 allow the poppet valve 40 to operate in a more stable manner due to the reduction in vacuum pulsation within the PCV valve assembly 12. As a result, erratic flow and noise issues are eliminated.

An alternate embodiment of a PCV valve assembly 112 is shown in FIG. 4. The PCV valve assembly 112 does not include an integral orifice molded within the cylindrical outlet stem 136 of the PCV valve assembly 112. Instead, an end of the vacuum tube 122 between the intake manifold 114 and a fluid outlet includes a flange 138 that defines an orifice 148. The end of the vacuum tube 122 incorporating the integrated orifice 148 is connected to the intake manifold 114. The opposite end of the vacuum tube 122 is connected to the cylindrical outlet stem 136 of the PCV valve assembly 112. The fluid inlet 124 is also connected to a vacuum tube 118 for further connection to the crankcase 116, such that the PCV valve assembly 112 is disposed between the two vacuum tubes 118 and 122. Operation of the PCV valve assembly 112 is otherwise identical to that described above with reference to FIGS. 2 and 3.

That the foregoing description shall be interpreted as illustrative and not in any limiting sense is thus made apparent. A worker of ordinary skill in the art would recognize that certain modifications would come within the scope of this invention. For that reason, the following claim should be studied to determine the true scope and content of this invention.

1. A positive crankcase ventilation valve assembly comprising:
a housing defining a fluid passage between a fluid inlet and a fluid outlet, wherein the housing includes an outlet stem having a flange that defines an orifice as the fluid outlet, and wherein the orifice has a restricted diameter less than a diameter of the outlet stem to reduce vacuum pulsation; and
a poppet valve movable in an axial direction in the housing.

2. The valve assembly as recited in claim 1 further including a crankcase and an intake manifold, wherein a first vacuum tube connects the fluid inlet to the crankcase and a second vacuum tube connects the fluid outlet to the intake manifold.

3. The valve assembly as recited in claim 2 wherein the first vacuum tube and the second vacuum are connected to the crankcase and the intake manifold, respectively, by a clamp.

4. The valve assembly as recited in claim 1 wherein the housing includes a first housing section and a second housing section secured together to define the housing.

5. The valve assembly as recited in claim 4 wherein the first housing section includes a threaded end that defines the fluid inlet.

6. The valve assembly as recited in claim 4 wherein the second housing section includes the outlet stem having the flange that defines the orifice, wherein the flange extends substantially perpendicular to the outlet stem.

7. The valve assembly as recited in claim 4 further including an orifice plate arranged between the first housing section and the second housing section to define a flow rate through the fluid passage.

8. The valve assembly as recited in claim 1 wherein the housing and the orifice are molded.

9. The valve assembly as recited in claim 1 further including a resilient member disposed in the housing to bias the poppet valve to a desired position in response to a vacuum acting upon the poppet valve.

10. The valve assembly as recited in claim 9 wherein the resilient member is a spring.

11. The valve assembly as recited in claim 9 wherein the vacuum is generated by engine cylinders to pull the poppet valve towards the orifice to allow a flow through the fluid passage.

12. The valve assembly as recited in claim 9 wherein the resilient member biases the poppet valve towards the fluid inlet when the vacuum acting upon the poppet valve decreases to prevent a flow through the fluid passage.

13. The valve assembly as recited in claim 1 wherein the second housing section includes ribs that extend radially inwardly towards the fluid passage to facilitate travel of the poppet valve in the fluid passage.

14. A positive crankcase ventilation valve assembly comprising:
a housing defining a fluid passage between a fluid inlet and a fluid outlet;
a poppet valve movable in an axial direction in the housing; and
a vacuum tube attached to the fluid outlet of the housing, wherein an end of the vacuum tube includes a flange that defines an orifice, and wherein the orifice has a restricted diameter less than a diameter of the vacuum stem to reduce vacuum pulsation.

15. An engine system comprising:
a positive crankcase ventilation valve assembly including:
a housing defining a fluid passage between a fluid inlet and a fluid outlet, wherein the housing includes an outlet stem having a flange that defines an orifice as the fluid outlet, and wherein the orifice has a restricted diameter less than a diameter of the outlet stem to reduce vacuum pulsation, and
a poppet valve movable in an axial direction in the housing;
a crankcase, wherein a first vacuum tube connects the fluid inlet to the crankcase; and
an intake manifold, wherein a second vacuum tube connects the fluid outlet to the intake manifold, wherein the positive crankcase ventilation valve assembly draws unburned gases and vapors from the crankcase into the intake manifold.

16. The engine system as recited in claim 15 wherein the housing includes a first housing section and a second housing section secured together to define the housing, and the first housing section includes a threaded end that defines the fluid inlet and the second housing section includes the outlet stem having the flange that defines the orifice, wherein the flange extends substantially perpendicular to the outlet stem.

17. The engine system as recited in claim 16 further including an orifice plate arranged between the first housing section and the second housing section to define a flow rate through the fluid passage.

18. The engine system as recited in claim 15 further including a resilient member disposed in the housing to bias the poppet valve to a desired position in response to a pressure acting upon the poppet valve,
wherein the vacuum is generated by engine cylinders to pull the poppet valve towards the orifice to allow a flow through the fluid passage, and
wherein the resilient member biases the poppet valve towards the fluid inlet when the vacuum acting upon the poppet valve decreases to prevent the flow through the fluid passage.

19. The engine system as recited in claim 18 wherein the resilient member is a spring.
